(19) United States
(12) Patent Application Publication
(10) Pub. No.: US 2011/0268643 A1
(43) Pub. Date: Nov. 3, 2011

(54) Production of Silicon

(76) Inventors: Johon R. Leblanc, Roanoke, VA (US); Diane S. LeBlance, Roanoke, VA (US)

(21) Appl. No.: 13/121,120

(22) PCT Filed: Oct. 9, 2009
(86) PCT No.: PCT/US09/05571

§ 371 Date: May 11, 2011

(30) Foreign Application Priority Data
Oct. 9, 2008 (US) 61104137

(51) Int. Cl. C01B 33/023; C22B 41/00

(52) U.S. Cl. 423/350; 75/689

(57) ABSTRACT

A process is provided for the production of elemental silicon from a silica containing glass melt including contacting the glass with a metal capable of undergoing a bimolecular reaction between the glass and metal at elevated temperature to reduce the oxidation state of the silicon in the glass to elemental silicon while oxidizing the metal, collecting, and optionally separating the elemental silicon. Similarly, elemental germanium is produced from a germania-containing glass.

A process is provided for the production of elemental silicon from a silica containing glass melt including contacting the glass with a metal capable of undergoing a bimolecular reaction between the glass and metal at elevated temperature to reduce the oxidation state of the silicon in the glass to elemental silicon while oxidizing the metal.

Elemental silicon is typically produced commercially in an electric arc furnace by the carbothermic reduction of silicon dioxide (quartz) with carbonaceous reducing agents, resulting in the formation of elemental silicon and carbon monoxide.

The present process can be carried out using conventional glass furnace technology that has been modified for the collection and optional separation of the elemental silicon product.

Glass furnaces typically include an elongated channel having an upstream end wall and a downstream end wall, side walls, a floor and a roof, referred to in the industry as the crown of the furnace, all made from appropriate refractory materials such as alumina, silica, alumina-silica, zircon, zirconia-alumina-silica, chrome oxide, fused silica, and the like. The roof may have an arcuate shape transverse to the longitudinal axis of the channel, or may be of another suitable design, typically positioned between about 3 to about 15 feet above the surface of the raw glass-forming material. The glass furnace includes two successive zones, an upstream melting zone and a downstream fining zone.

Raw glass-forming material is charged into the upstream melting zone of the furnace using a charging device of a type well known in the art. The raw glass-forming material may be a mixture of raw materials typically used in the manufacture of glass. The composition of the raw glass-forming material (or batch) is dependent on the type of glass being produced. Normally, the material comprises, among others, silica containing materials including scrap glass commonly referred to as cullet.

### BRIEF DESCRIPTION OF THE DRAWINGS

FIG. 1 is a schematic, cross-sectional elevational side view of an apparatus comprising a glass melting furnace for carrying out the subject process.

FIG. 2 is a schematic, cutaway top plan view of the apparatus for carrying out the subject process.

FIG. 3 is a schematic, cross-sectional elevational view of the apparatus for carrying out the subject process, shown transverse to the view of FIG. 1 and facing the downstream section of the furnace.

FIG. 4A is a schematic, cross-sectional side elevational view of the cooling section of the apparatus for carrying out the subject process.

FIG. 4B is a schematic, cutaway elevational view of the cooling section of the apparatus for carrying out the subject process, shown transverse to the view of FIG. 4A and facing the inlet to the cooling section.

FIG. 4C is a schematic, cutaway elevational view of another embodiment of the cooling section of the apparatus for carrying out the subject process, shown transverse to the view of FIG. 4A and facing the inlet to the cooling section.

FIG. 5 is a schematic, perspective view of the outside cooling section of the apparatus for carrying out the subject process, showing an outlet for product.

FIG. 6 is a schematic, cross-sectional elevational view of another embodiment of the cooling section of the apparatus for carrying out the subject process, showing alternative outlet means.

FIG. 7A is a schematic, cross-sectional side elevational view of an alternate embodiment of the cooling section of the apparatus for carrying out the subject process.

FIG. 7B is a schematic, cutaway elevational view of the alternate embodiment of the cooling section of the apparatus for carrying out the subject process, shown transverse to the view of FIG. 7A and facing the inlet to the cooling section.

FIG. 8 is a schematic, cross-sectional view of the inlet to the cooling section of the apparatus.

### DESCRIPTION

The process includes the formation of elemental silicon from glass material containing silica, and a metal in contact with the glass, the combination capable of undergoing a bimolecular reaction between the glass and metal at elevated temperature. The choice of metals capable of providing this reaction is thus limited. Aluminum is a practical and economical metal capable of achieving this reaction, and thus the present process will be described herein with reference to aluminum as the metal used in combination with the silica containing glass materials. Other metals capable of reducing silica to elemental silicon at elevated temperatures suitable for melting the silica containing glass materials and optionally elemental silicon, may be used as well. It is advantageous for the resulting metal oxide to be a glass former, and/or enter into solution in the glass melt, as will be discussed below.

In one illustrative embodiment, the bimolecular reaction comprises the conversion of elemental aluminum(Al⁰) to aluminum oxide (Al₂O₃) and silicon dioxide (SiO₂) to elemental silicon (Si⁰) in a silicate glass melt. This process requires the components of the reaction to reach the energy of activation (Eₐ) for the conversion to take place. Since the molecules must collide, both the aluminum and the silicate glass will typically be converted to a molten state.

Reaching the transition state for the reaction at its minimum temperature will result in the components undergoing some conversion, but the time required to achieve complete conversion, if complete conversion is even possible at just above the energy activation barrier, is too lengthy for practical fabrication of silicon according to the subject process. As the temperature of the melt increases, however, molecular collisions increase and both the rate of conversion and the purity of the final product increases.

By way of illustration but not limitation, using a common soda-lime silicate glass as a reference, conversion from silica and aluminum to silicon and aluminum oxide would take place at the melt log viscosity (poise) of 7.65 (765 mPa·s) (at approximately 710° to 720° C.). Decreasing the melt log viscosity to 1.5-2 poise (150-200 mPa·s) (approximately 1450° to 1540° C.) exceeds the melting point of silicon (about 1414° C.) and significantly increases the reaction rate. The temperature of the glass melt may thus be maintained above the melting point of elemental silicon.

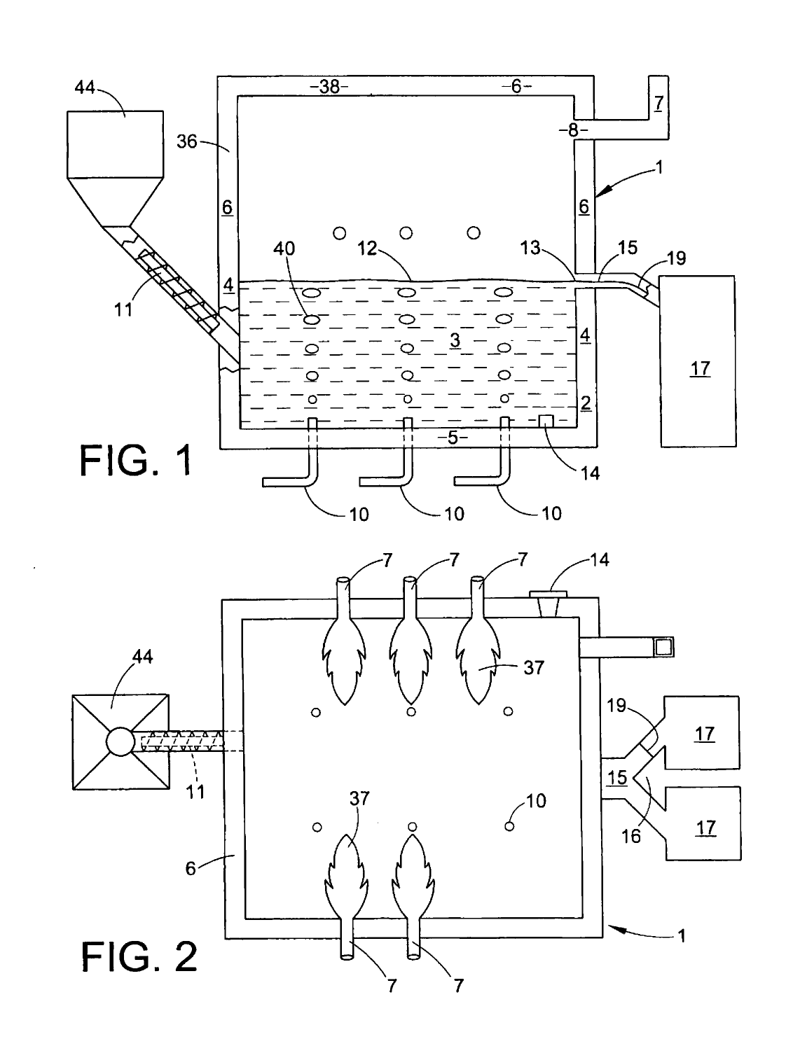

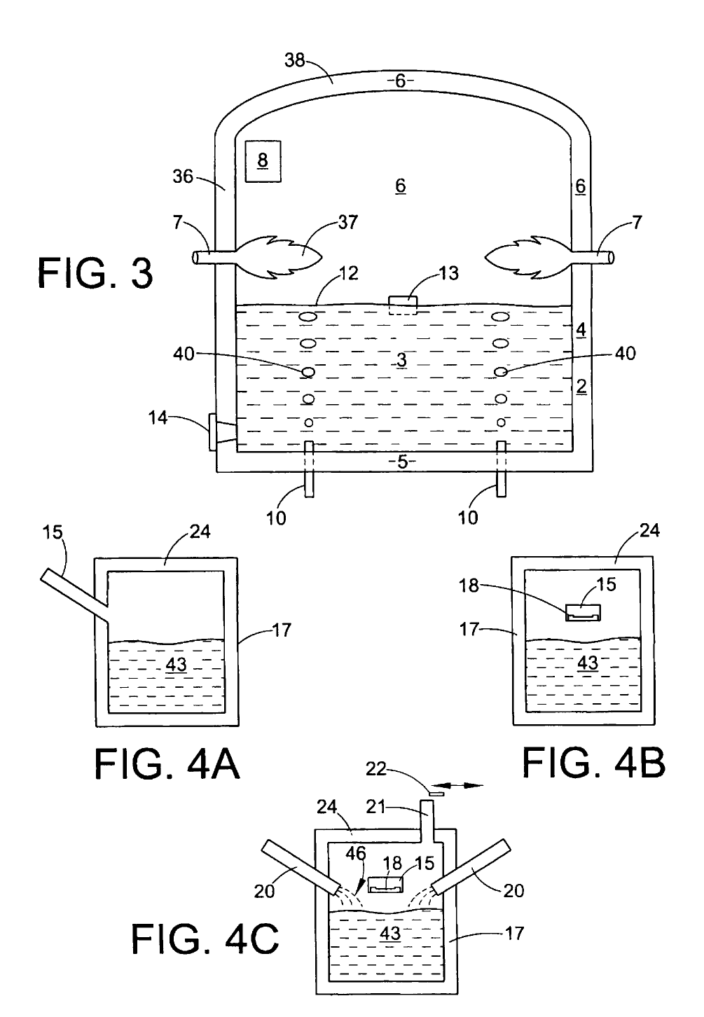

As shown in FIGS. 1, 2 and 3, the subject process may be carried out in a vessel or furnace 1 in which silica containing glass material is melted, and in which metallic aluminum is added into the glass melt, premixed in the batch and/or added separately. Elemental silicon, along with some molten glass, is drawn from the furnace, as is described in more detail below. The furnace basin 2, including the sides 4 and the floor or bottom 5 of the basin, which is the portion of the glass melter furnace that will be in contact with the molten glass 3, will typically be constructed with refractory materials that have suitable glass corrosion resistance sufficient to last at least one year before repair.

The superstructure 6 of the furnace, comprising walls 36 and the roof or crown 37, is that portion above the basin, and may be equipped with burners 7, at least one exhaust port 8, and an exhaust stack or chimney 9. The burners 7 may be positioned at the furnace walls 36 as in conventional glass furnaces, optionally associated with regenerators or recuperators. In certain embodiments, at least one burner may be positioned at the roof or crown 38.

A recent trend in the glass industry has been to install roof-mounted burners, such as oxygen-fuel burners, in refractory lined glass melting furnaces. This technology approach is described in U.S. Pat. No. 6,237,369 to LeBlanc et al., with respect to using roof-mounted burners as the primary source of heat in a glass melting furnace, and in U.S. Pat. No. 6,422,041 to Simpson et al., with respect to the use of at least one oxygen-fuel burner in the roof of a glass melting furnace to boost production capacity or maintain current production capacity as a result of deterioration of existing heat recovery equipment such as recuperators or regenerators. U.S. Pat. No. 6,705,117 to Simpson et al. describes at least one staged combustion oxy-fuel burner mounted in the roof of a glass furnace, positioned over the glass-forming batch material entering the furnace. These patents are hereby incorporated by reference as if fully written out below.

The refractory materials in the superstructure will typically be able to withstand the furnace operating temperatures and glass vapor attack for at least one year. The basin and superstructure refractories will also typically be heavily insulated.

The furnace may advantageously be heated with fossil fuel, using either a hydrocarbon gas or oil. This can be accomplished using either air-fuel or oxy-fuel combustion. Firing the furnace with an oxygen-fuel mixture would permit a smaller combustion space above the basin and a smaller exhaust port and stack than would air-fuel combustion.

Suitable fuels for combustion include, but are not limited to, methane, natural gas, liquefied natural gas, propane, hydrogen, liquefied propane gas, butane, low BTU gases such as town gas, producer gas or the like, vaporized or atomized oil, kerosene or diesel fuel, or mixtures thereof, at either ambient temperature or in preheated form.

Oxidants for combustion include air; oxygen-enriched air, containing greater than about 50 volume percent oxygen to about 80 volume percent, such as is produced by filtration, absorption, membrane separation, or the like; non-pure oxygen such as is produced by, for example, a vacuum swing adsorption process and containing about 80 volume percent to about 95 volume percent oxygen; and “industrially” pure oxygen containing about 90 volume percent to about 100 volume percent oxygen, such as is produced by a cryogenic air separation plant.

The combustion space should be maintained with either a neutral atmosphere or a reducing atmosphere, rather than an oxidizing atmosphere. This can be maintained by either tiring the burners with a proportion of air or oxygen slightly below stoichiometric for the combustion reaction (oxidant-lean), or by introducing a neutral gas, e.g. nitrogen, or a reducing gas, e.g. natural gas or methane, to the furnace atmosphere, in one embodiment up through the bottom of the basin.

The introduction of a gas through the bottom of the furnace is a common practice in the glass container and flat glass industries, and is commonly referred to as bubbling with gas bubbler tubes or “bubblers” 10. Bubbles 40 of fluid, such as gas, optionally exhaust gas, water or steam, may emanate from the bubblers 10 into the glass bath 3, that is, the bulk glass melt, within the melting zone. Sub-stoichiometric submerged combustion may also be used where fuel and/or oxidant are bubbled into the bath.

While using bubblers in the subject process is not essential, it does provide an additional advantage of further mixing the melt to expedite the silica to silicon conversion. Bubbling also can raise the bulk glass temperature in the basin, which will expedite the silica to silicon conversion, as discussed above. A method for melting glass forming material which utilizes bubblers is described in U.S. Pat. No. 6,722,161 to John R. LeBlanc, which is hereby incorporated by reference as if fully written out below.

There are different approaches to introducing cold silica containing glass materials and metallic aluminum into the melting furnace. According to one embodiment illustrated in FIG. 1, broken glass, referred to as cullet, and pieces of aluminum, are introduced through the side of the basin, below the melt surface, using a screw charger 11, in communication with a materials hopper 44, to push both components into the molten glass. According to another embodiment, glass cullet and metallic aluminum are introduced through a screw charger into the melting furnace above the surface of the melt. In a further embodiment, the silica containing glass materials and the metallic aluminum can be introduced into the melting furnace separately.

Although this process is applicable to various glass compositions, it is particularly well suited for a glass called soda-lime-silica. This glass is produced from three basic ingredients: silica (sand), soda ash, and limestone. Essentially all bottles and flat glass (e.g., window glass), and most tableware glass are made of soda-lime-silica glass. Other glass-forming materials include but are not limited to feldspar, nepheline syenite, dolomite, potash, borax, kaolin clay and alumina.

In certain embodiments, no raw glass batch materials are used to form the glass melt. Unmelted batch materials may adhere to the elemental silicon formed, production time would be greater using raw materials, and both capital and operating costs would be increased. Rather, low cost scrap cullet is melted to form the glass melt, and in particular embodiments, soda-lime-silica glass. Even low quality recycled cullet may be used to form the glass melt, as any ceramics or metals other than silicon that are released will settle to the bottom of the basin. The use of cullet low in iron, however, would reduce iron contamination. For example, float container glass cullet or flint flat glass cullet may have an Fe₂O₃ content less than about 0.05%.

A further advantage to the use of this type of glass feed is the ability of bubbles coming out of the glass solution may buoy elemental silicon particles. The susceptibility of this type of glass formed in association with the product elemental silicon to fracture upon cooling, for ease of separation from the silicon, will be discussed below.

The atmosphere above the melt is advantageously non-oxidizing in either charging embodiment, but particularly with respect to the second embodiment. Bubbling the glass melt with a neutral gas and firing the burners above the glass melt with a sub-stoichiometric (oxidant-lean) flame is more highly recommended with this second charging embodiment (charging above the melt) than the first embodiment where the cullet and aluminum are screw-fed into the glass melt below the melt surface. The reason is that an oxidizing atmosphere may oxidize the aluminum to aluminum oxide, (Al₂O₃, commonly referred to as alumina), which will not reduce silica to silicon.

The glass composition in the basin will change as silicon is formed. The change will involve a reduction in silica and an increase in alumina. It is desired that the alumina dissolve in the glass melt. The higher the glass temperature, the greater the amount of alumina that will go into solution in the glass. Bubbling will also promote increased alumina solution in the glass melt.

Consequently, the glass in the basin may be periodically flushed with the same glass composition, but without aluminum, as that which is being fed into the furnace with aluminum, optionally for a full clean out. The glass composition used for flushing the basin may be soda-lime-silicate cullet, e.g. container glass or flat glass. Alternatively, the basin can be drained and then flushed.

The glass that will be flushed out of the basin could be drained through a drain hole or drain spout 14 in the lower half of the basin. If this latter option is selected, the by-product higher alumina glass composition could be collected and used to make insulating glass fiber. For example, vitreous aluminosilicate fibers typically have a nominal alumina to silica ratio of about 60:40 to 40:60. There are various techniques for determining the ratio of alumina and silica in the basin glass. Although a wet chemical analysis or X-Ray fluorescence analysis could determine the composition, these could be too time-consuming if operating a relatively small furnace. Faster approaches would be to measure physical properties of the glass, e.g. index of refraction, density or the like.

According to a first embodiment, the elemental silicon that is formed by the thermally induced reduction of silica by aluminum will rise to the surface 12 of the glass melt 3 in the basin. This results when the glass has a higher density than silicon, as is the case with soda-lime-silica glass. Another factor that will cause the silicon will rise to the surface is that when gaseous bubbles come out of solution in the glass, they can attach to and buoy the silicon in the melt.

Alternatively, a submerged deep throat or a glass tubing process may be provided to extract alumina-rich melt from the bottom of the basin, while silicon-rich melt is extracted from the surface, optionally in a glass pipe updraw process, or by using a water cooled skimmer block.

With respect to the first embodiment, the elemental silicon, along with some molten glass, can be drawn from an opening or slot at the top of the basin 13. In certain embodiments, the height of the opening can be approximately two to three inches high. The width of the slot will depend in part on the size of the furnace, which in turn is dependent upon the desired production rate of silicon.

The glass and silicon will exit the furnace through the opening 13 and into a trough 15. The trough 15 may be enclosed with refractory material and insulation. As shown in FIG. 8, the glass and silicon will flow from the furnace in a channel 18 located in the trough 15. The channel may comprise two sides 41 and a bottom 42. Fused cast alumina would be a suitable refractory material for the channel, although other refractory materials such as fused cast α-β alumina or graphite could be used as well. The trough will be sloped down and away from the furnace slot 13. In one embodiment, an angle of at least about 30 degrees is used.

It is advantageous for the atmosphere in the trough above the channel to be maintained with a neutral or reducing atmosphere, without free oxygen to re-oxidize the silicon product at the elevated operating temperature. The trough 15 will enter a vessel that will be referred to as a cooling box 17 in this description. While it is acceptable that the trough enters only one cooling box, in some embodiments the trough may be divided into at least two troughs, such as with a “Y” 16 in the trough after exiting the furnace, as shown in FIG. 2. Each trough would be directed to a different cooling box 17. A shut-off gate 19 may be positioned in each trough after the “Y”, to limit flow to only one cooling box at a time. In this way, one cooling box 17 may be emptied while another is accepting silicon and molten glass. Of course, more than two cooling boxes may be used in the process, depending on production rate, capacity, and considerations. The subject process may be carried out as a batch, a semi-continuous, or a continuous process.

There are different embodiments possible for the design of the cooling box 17 used to collect and potentially separate elemental silicon from the glass. One series of designs in one embodiment will produce silicon with a relatively high associated glass content and will be referred to herein as HGC. Another series of designs in another embodiment will produce silicon with a low associated glass content, referred to herein as LGC. The glass that is associated with the elemental silicon may be intermixed with silicon particles or adhered to the surface of the silicon. The uses for the HGC and LGC silicon may differ.

The cooling box for making HGC silicon may be designed, as illustrated in FIGS. 4A, 4B and 4C, to cool the glass and silicon mixture 43 to a temperature that would permit the elemental silicon or a mixture of elemental silicon and glass to be removed in solid form. During the period of time when the elemental silicon and glass material is open or exposed to the atmosphere, such as for removal, the temperature is maintained low enough to avoid oxidation of the elemental silicon to silica, in certain embodiments below about 285° C. (about 400° F.).

In one embodiment, illustrated in FIGS. 4A and 4B, the sides and bottom of the cooling box may be constructed from a high thermal conductivity refractory, such as fused cast α-β alumina, and the cooling box may be constructed with a steel roof 24. A system of fans (not shown) may direct a cooling air or gas stream, or a water spray, on some or all exterior surfaces of the cooling box. A rectangular cooling box is shown for convenience, but any shape capable of construction and operation can be used in the subject process.

One way to cool the silicon quickly is to spray it with a liquid, such as water, as it enters the cooling box, as illustrated in FIG. 4C. This design may include spray nozzles 20 in the walls of the cooling box above the glass and silicon mixture 43. The rate of addition of water by spraying may be controlled to prevent excessive pressure buildup in the cooling box or the glass melter, as steam can pass upstream through the trough. A small chimney 21 may be installed in the roof or the upper end of a wall to allow some of the steam generated by the water spray 46 on the hot HGC silicon to escape. A damper 22 may be installed on the top of the chimney to maintain a positive pressure in the cooling box 17, to inhibit air from entering the cooling box 17 and furnace. Other liquids capable of quenching the silicon may be used, such as a cryogenic liquid, oil, or even the molten reducing metal, such as aluminum.

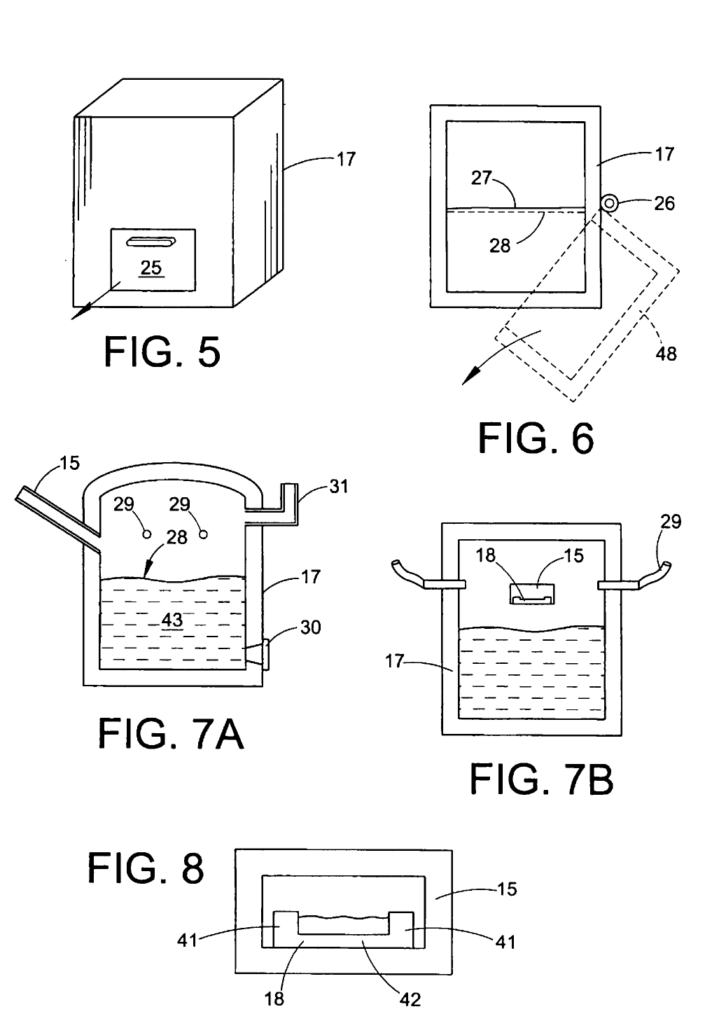

As illustrated in FIG. 5, one embodiment to provide for the removal of the HGC silicon from the cooling box 17 is to construct one wall of the cooling box with or as a door 25 that could be removed to expose the HGC mixture. Another embodiment to provide for the removal of the HGC silicon from the cooling box illustrated in FIG. 6, is to construct a hinge 26 in one wall of the basin 48 in the cooling box 17 that would allow the basin to be rotated, such as up to 90 degrees, exposing the mixture. The refractory construction for the basin and upper structure of the cooling box is therefore designed to allow for the separation of the two parts. In certain embodiments, the separation 27 may take place approximately two inches above top of the HGC surface 28. This surface 28 is often referred to as the “glass line” or “metal line” in the glass industry.

The cooling box for separating LGC silicon could be operated “hot”. In one embodiment shown in FIGS. 7A and 7B, this would utilize fossil fuel burners 29, in certain embodiments oxy-gas burners, positioned in the upper walls of the cooling box 17, above the top surface 28 of the LGC bath. All walls, bottom, and roof of the LGC cooling box 17 are advantageously well insulated. The cooling box bottom may comprise fused cast alumina, fused cast α-β alumina or graphite refractory, and the cooling box walls and roof may comprise the same, or additionally fused cast alumina-zirconia-silica (AZS) refractory. To minimize or eliminate oxidizing the silicon product, the entire cooling box is maintained substantially free of air ingression. In addition, the burners may be operated at a slightly sub-stoichiometric oxygen to fuel ratio.

The glass will settle to the bottom of the cooling box and the elemental silicon will rise to the top of the LGC mixture 43. The molten glass can be drawn through a drain hole 30 in, or near the bottom of, one of the walls. When the upper portion, for example but not by way of limitation, one-third to two-thirds of the LGC cooling box basin comprises primarily elemental silicon, the burners can be shut off. The silicon may be allowed to cool to approximately 1200° F. (about 650° C.), optionally sprayed with a liquid, such as water, and then is removed from the cooling box. The water or other liquid will shatter any residual glass that might be adhering to the silicon.

It is desirable to separate the glass from the silicon. In addition to separation by thermal shock, another embodiment produces elemental silicon with a glass that has a higher thermal coefficient of expansion than does silicon, so that the glass is fractured during cooling. For example, soda-lime-silicate glass has a higher thermal coefficient of expansion than does silicon.

A chimney 31 may also be utilized in the LGC cooling box embodiment (shown in FIG. 7A) that is operated by spraying water on the silicon. The chimney 31 may be kept closed except during firing of the burners, and while water is sprayed on the silicon. Another LGC cooling box embodiment allows the silicon and glass to cool to about room temperature without spraying water.

The LGC cooling box may also utilize a removable wall or door 25 to remove the cooled LGC silicon and glass, or a hinged cooling box basin 26 could be rotated away from the upper structure as described above for HGC silicon removal.

Either the HGC silicon or LGC silicon, which each comprise elemental silicon with differing proportions of associated residual glass, can undergo standard procedures for further purification of the silicon.

In other embodiments, the LGC or HGC silicon product resulting from the subject silicon production process may be utilized directly to make other products. In one embodiment, the LGC or HGC silicon product that is recovered from the subject process is ground and screened to a desired particle size, for purposes of illustration but not limitation, e.g. twenty mesh. A uniform, predetermined thickness of these ground and screened particles (together with any appropriate materials and/or chemicals) are applied to a glass sheet/plate. A second sheet of glass (also optionally associated with any appropriate materials or chemicals) is applied over the first glass sheet with the silicon particles between the two sheets of glass. The glass/particle/glass laminate is heated up to a temperature above the softening points of both the HGC/silicon or LGC/silicon and the sheet glass. For example, if both glasses are soda-lime-silica, their softening point would typically fall in the 1330-1380° F. (about 720-750° C.) range. This temperature may be held until the glass in the HGC/silicon or LGC/silicon and the glass sheets have thoroughly fused together. This process advantageously is conducted under a neutral or slightly reducing atmosphere.

In this embodiment, the sheet glass may advantageously have a coefficient of thermal expansion that is lower than that of the elemental silicon. Also, the sheet glass and silicon laminates or can be built up in multiple layers, with different additives provided in the different layers.

An example of a resulting product is suitable for use in photovoltaic devices. The silicon product may be utilized as a solar cell substrate (such as for epitaxy or diffusion), or may comprise an active p-type layer (with or without a p-type dopant such as boron), with an adjacent n-type layer being produced by introducing an n-type dopant such as phosphorous or phosphene to one side of the silicon, forming a cell junction therebetween. A metal or other conductor may be contacted to one surface of the silicon, and conductive collector fingers or grid to the other. The conductor and/or collectors (as well as any dopant materials) may be associated with the sheets of glass used to sandwich the elemental silicon material. The silicon product can similarly be utilized in a rectifier, diode (such as LEDs) or the like.

In another separation method embodiment, after the LGC or HGC silicon product is ground, the elemental silicon can be separated from the fine grained glass by centrifugation. In yet another embodiment, the top layer of glass containing elemental silicon material may be rolled out through a set of refractory rollers, for example, followed by thermal shock or crushing of the composite between additional rollers. After cooling, the silicon may be separated from the glass by a sink-float process. Alternatively, an electrolysis separation process may be employed.

In another embodiment, the subject process is provided for the production of elemental germanium from a germanate, or germania-containing, glass melt comprising contacting the germania-containing glass in the glass melt with a metal capable of undergoing a bimolecular reaction between the germania-containing glass and metal at elevated temperature to reduce the oxidation state of germanium in the glass to elemental germanium while oxidizing the metal, and collecting the elemental germanium, and optionally separating the elemental germanium.

For example, in the electrochemical potential or redox series, aluminum is more strongly reducing than germanium, such that elemental aluminum will reduce germania (GeO₂) at the appropriate temperature.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. A process for the production of elemental silicon from a silica containing glass melt comprising contacting the silica containing glass in the glass melt with a metal capable of undergoing a bimolecular reaction between the silica containing glass and metal at elevated temperature to reduce the oxidation state of silicon in the glass to elemental silicon while oxidizing the metal, and collecting the elemental silicon, and optionally separating the elemental silicon.

2. The process of claim 1 wherein the metal is aluminum.

3. The process of claim 1 wherein the glass melt comprises a soda-lime-silica glass melt.

4. The process of claim 1 including maintaining the temperature of the glass melt above the melting point of elemental silicon.

5. The process of claim 1 including maintaining a non-oxidizing atmosphere above the glass melt.

6. The process of claim 1 including firing at least one burner above the glass melt with a sub-stoichiometric (oxidant-lean) flame.

7. The process of claim 1 including bubbling the glass melt with:
a) at least one of a neutral gas or a reducing gas; or
b) at least one of exhaust gas, water or steam.

8. The process of claim 1 including collecting elemental silicon and molten glass from the bulk glass melt, and cooling the elemental silicon and glass.

9. The process of claim 1 including separating the elemental silicon from the glass.

10. The process of claim 9 separating the elemental silicon from the glass by thermal shock.

11. The process of claim 10 comprising spraying the elemental silicon and glass with a liquid, optionally water.

12. The process of claim 9 wherein the glass has a higher thermal coefficient of expansion than the thermal coefficient of expansion of silicon, whereby the glass is separated from the silicon by fracturing during cooling.

13. A process for the production of elemental silicon from a silica containing glass melt comprising:
charging at least one of silica containing glass forming materials or silica containing cullet to a melting furnace;
combusting a fuel and an oxidant to heat the at least one of silica containing glass forming materials or silica containing cullet in the melting furnace to form a glass melt;
contacting the glass melt with a metal capable of undergoing a bimolecular reaction between the silica containing glass and metal at elevated temperature to reduce the oxidation state of silicon in the glass to elemental silicon while oxidizing the metal, by charging the metal to the furnace separately from and/or together with the silica containing glass forming materials or silica containing cullet;
heating the glass melt to at least the temperature of the bimolecular reaction to effect the reduction of silica to elemental silicon;
collecting the elemental silicon and molten associated glass from the glass melt;
cooling the elemental silicon and molten associated glass, and optionally separating the cooled associated glass from the elemental silicon.

14. The process of claim 13 wherein the metal is aluminum.

15. The process of claim 13 wherein the glass melt comprises a soda-lime-silica glass melt.

16. The process of claim 13 including maintaining the temperature of the glass melt above the melting point of elemental silicon.

17. The process of claim 13 including maintaining a non-oxidizing atmosphere above the glass melt.

18. The process of claim 13 including bubbling the glass melt with:
a) at least one of a neutral gas or a reducing gas; or
b) at least one of exhaust gas, water or steam.

19. The process of claim 13 wherein elemental silicon and molten glass is drawn from the furnace into a trough in communication with at least one cooling box for collecting the elemental silicon and molten associated glass.

20. The process of claim 19 wherein the elemental silicon and molten associated glass are cooled in the cooling box to solid form, optionally by at least one of:
directing a water spray, cooling air or a cooling gas stream onto at least one exterior surface of the cooling box, or,
spraying the elemental silicon and molten glass with a liquid, optionally water.

21. The process of claim 19 wherein the associated glass is initially maintained in a molten state in the cooling box, and at least a portion of the molten glass is drawn from the cooling box, allowing the elemental silicon to collect at the surface of the molten glass, and thereafter cooling the elemental silicon and molten residual glass.

22. The process of claim 21, including cooling the elemental silicon and molten residual glass by spraying a liquid, optionally water, on the elemental silicon, and shattering the cooled residual glass.

23. The process of claim 21, including separating the residual glass from the elemental silicon by at least one of thermal shock, or, wherein the glass has a higher thermal coefficient of expansion than the silicon, fracturing the glass during cooling.

24. The process of claim 13, wherein the cooled associated glass is separated from the elemental silicon by crushing or grinding the elemental silicon and associated glass to form a mixture, and separating the mixture.

25. A process for the production of elemental germanium from a germania-containing glass melt comprising contacting the germania-containing glass in the glass melt with a metal capable of undergoing a bimolecular reaction between the germania-containing glass and metal at elevated temperature to reduce the oxidation state of germanium in the glass to elemental germanium while oxidizing the metal, and collecting the elemental germanium, and optionally separating the elemental germanium.
